(19) United States
(12) Patent Application Publication
(10) Pub. No.: US 2009/0198681 A1
(43) Pub. Date: Aug. 6, 2009

(54) REAL PROPERTY EVALUATION AND SCORING METHOD AND SYSTEM

(75) Inventors: Ian Marc Burnstein, Bloomfield Hills, MI (US); Neal David Welbourne, Beverly Hills, MI (US)

Correspondence Address: QUINN LAW GROUP, PLLC, 39555 ORCHARD HILL PLACE, SUITE # 520, NOVI, MI, 48375, US

(73) Assignee: XSITE VALIDATION, LLC, Farmington Hills, MI (US)

(21) Appl. No.: 12/362,704

(22) Filed: Jan. 30, 2009

Related U.S. Application Data
(60) Provisional application No. 61/025,404, filed on Feb. 1, 2008.

(51) Int. Cl. G06F 17/30

(52) U.S. Cl. 707/5; 707/E17.071

(57) ABSTRACT

A method for evaluating a parcel of real estate includes recording a location and intended use of the parcel, generating a geocoded graphic of an area including the parcel, and defining a trade area. Boundaries of the trade area are demarcated on the graphic, and databases are accessed to determine characteristics of the trade area. The characteristics are processed into an objective score. A customized report is generated including the score and an analysis of the characteristics, and is displayed on the computer in a downloadable format. A server for generating the report includes a computer-readable medium, a processor, and an algorithm. The algorithm records a location and intended use of the parcel on the computer-readable medium, determines a trade area, accesses data sources to determine a set of trade area characteristics, and processes the characteristics using the processor to calculate an objective score based on the intended use.

### CROSS REFERENCE TO RELATED APPLICATIONS

This application claims priority to and the benefit of U.S. Provisional Patent Application No. 61/025,404, filed on Feb. 1, 2008, which is hereby incorporated by reference in its entirety.

### TECHNICAL FIELD

The present invention relates generally to the evaluation of real properties or parcels of real estate in preparation for a real estate transaction or development project, and more particularly to a method and system for automatically evaluating and objectively rating a parcel for an intended industry use.

### BACKGROUND OF THE INVENTION

The decision process relating to the evaluation and validation of a particular real estate property or parcel is ordinarily supported by an extensive amount of preparatory research and data analysis. That is, in order to make a sound business decision, a prudent interested party such as a banker, developer, business owner, or an investor ordinarily analyzes the relative benefits and drawbacks of various candidate properties during the site-selection process. Numerous data sources are ordinarily separately researched or consulted in order in an attempt at determining the relative merits of each candidate property.

While the often widely scattered data sources can contain valuable information, existing site validation methods and systems utilizing such data sources remain less than optimal. That is, the process of searching each individual data source separately can be exhaustive, and typically lack efficient means for objectively evaluating the parcel for a particular industry use. Likewise, conventional evaluation methods are often largely subjective, and lack an automatic and seamless capability of synthesizing disparate search results into a meaningful and cohesive set of comparative data that is conducive to the overall efficiency of a real estate site validation process.

### SUMMARY OF THE INVENTION

Accordingly, a method is provided for objectively evaluating a parcel of real estate for an intended use, i.e., a selected industry use as that term is understood in the art and explained hereinbelow. The method automatically analyzes and grades or ranks the relative merits of a particular real property or parcel for an intended use, and automatically generates and displays a synthesized and customized report to a user. The customized report can be transmitted to the user's computer and displayed on a web browser thereof, with the report objectively scoring, grading, or otherwise quantifying the results of the computer-based analysis. The content of the generated report is uniquely suited to assist bankers, developers, investors, business owners, real estate professionals, and other interested parties in evaluating a particular parcel of real estate.

The method of the invention can be embodied in algorithmic form and stored or recorded on a tangible computer-executable or computer-readable medium, with the medium being resident on or accessible by a host machine or serve, and therefore universally accessible by the user over the Internet or other suitable network connection or communications link. Execution of the algorithm ultimately results in the generation of the customized report which, as noted above, objectively synthesizes disparate information or metrics about the parcel that is automatically collected from one or more sources of data and processed using the server.

The report itself provides a comprehensive analysis of a candidate property or parcel by synthesizing detailed information from one or multiple data sources into one or more concise and easy-to-read and downloadable report formats. For example, the report can provide valuable information to the user relating to the prospective market and/or proposed use of the parcel, including but not limited to the unique demographics and competitive landscape. Within the scope of the invention, an objective scoring model is executed to generate an exclusive objective score as an integral part of the report, which can be in the form of a scorecard or score as set forth herein. The scorecard objectively grades or ranks a particular parcel's relative viability for a specific intended use. As will be instantly recognized by one of ordinary skill in the art, such a scorecard can further optimize the performance of due diligence during the various stages of a real estate-related decision process.

In particular, the method includes recording each of a location and an intended use of the parcel on a first computer-readable medium that is accessible by the server, and generating a geocoded graphic of an area around the parcel using the location and a geographic information system or GIS-based webservice. A trade area is automatically defined by the server, with the boundaries of the trade area being demarcated on the geocoded graphic. After executing these steps, the method queries or accesses one or more databases to determine various metrics or characteristics of the trade area, then processes these characteristics on the server to calculate or determine an objective score grading or ranking the trade area for the intended use. A customized report containing the objective score is generated on the server and displayed on the user's computer in one or more predetermined and downloadable formats.

Additionally, a host machine or server includes one or more memory locations or a computer-readable medium, a microprocessor unit or processor, and the algorithm noted above, which is suitable for executing the method of the invention, and which can be resident on the computer-readable medium of the server or otherwise readily accessed by the server. The algorithm can be separated from the user by a suitable firewall to increase system security, and is accessible by the user over the Internet or other suitable communications link using a computer or other electronic device having a suitable web browser. That is, a user logs in to the server from any convenient location, and the server automatically executes the algorithm, with the resultant customized report being displayed on the user's computer or electronic device in one or in multiple downloadable formats.

In an exemplary embodiment, the report is provided to the user in at least four unique formats, i.e., Word, Excel®, Portable Document Format (PDF), and HyperText Markup Language (HTML), to facilitate use and dissemination of the report. However, the report can be provided in additional or fewer document formats, or different document formats altogether, without departing from the intended scope of the invention.

The above features and advantages and other features and other advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a real estate evaluation system usable with a method for analyzing and objectively scoring a real estate property or parcel in accordance with the invention;

FIG. 2 is a graphical flow chart describing a method or algorithm usable with the system of FIG. 1; and

FIG. 3 is an exemplary score card that generated as a part of a customized report using the method shown in FIG. 2.

### DESCRIPTION OF THE PREFERRED EMBODIMENTS

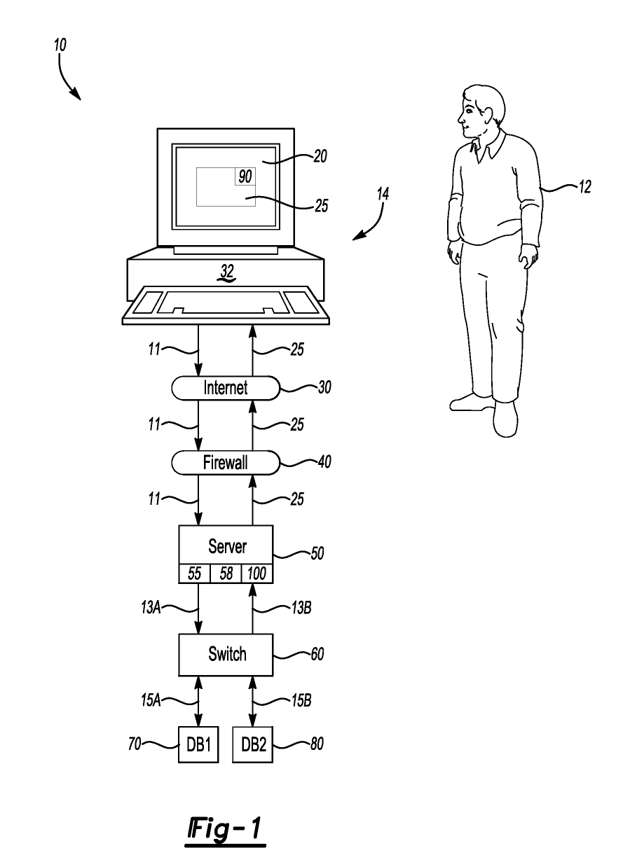

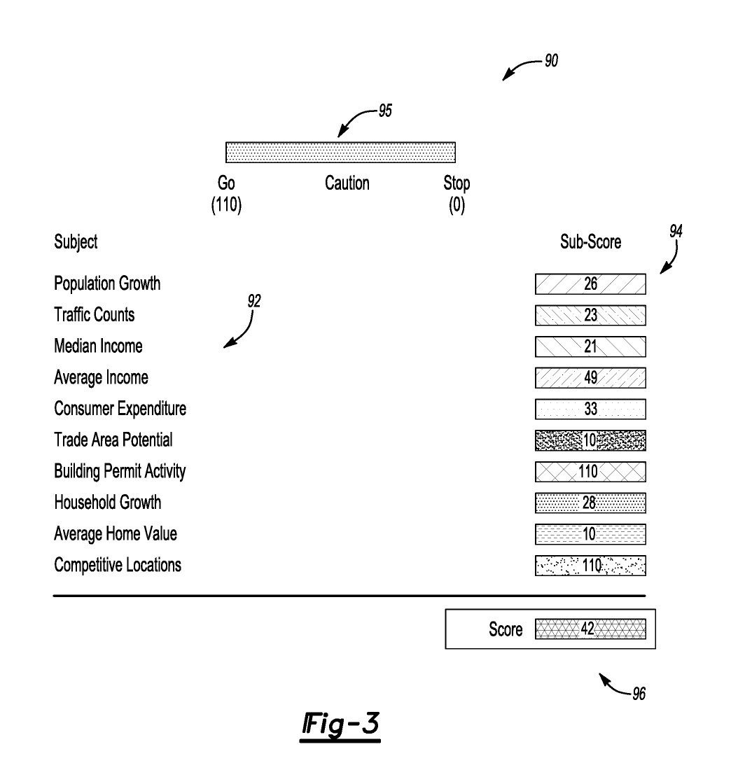

Referring to the drawings, wherein like reference numbers correspond to like or similar components throughout the several figures, and beginning with FIG. 1, a real estate parcel validation system 10, hereinafter referred to as the system 10 for simplicity, is configured or adapted for automatically generating and displaying a customized report 25 as described below. That is, a host machine or server 50 can be remotely accessed by a user 12. Upon execution of an algorithm 100 that is resident on or accessible by the server 50, the report 25 is automatically transmitted back to the user 12 over the Internet 30 or other suitable communications network, as indicted by the corresponding arrows 25 representing the electronic dissemination of the report 25. The report 25 is ultimately displayed on the computer 14 in one or more downloadable formats via a web browser 20 as described below, with the report 25 including at least an objective scorecard 90 as will described below with reference to FIG. 3.

The system 10 as a whole is configured to automatically analyze and/or evaluate one or more real estate properties or parcels for a particular intended use, as that term is understood in the art and described below. That is, a user 12, such as a banker, developer, investor, business owner, real estate professional, etc., uses the computer 14 to remotely accesses the server 50 in order to efficiently obtain and synthesize a diverse set of information relating to a prospective or candidate property or parcel, such as particular lot, acreage, existing building or facility, etc.

The computer 14 can be configured as a personal computer having a microprocessor unit or a processor 55, computer-readable media or memory 32, and the capability of accessing the Internet 30 or another suitable communications network. Alternately, the computer 14 can be embodied as another suitable electronic device, such as a cell phone or a personal digital assistant (PDA), having a browser 20 and the requisite memory and processor functionality. The browser 20 can be embodied as any commonly available web browser, such as but not limited to Internet Explorer®, Firefox®, Thunderbird™, Safari®, or other existing or emerging web browsers.

The host machine or server 50 includes the algorithm 100, a central processing unit or processor 55, and a tangible computer-readable storage medium 58 such as a single magnetic hard drive, a redundant array of independent disks (RAID)-type hard storage device, and/or another suitable memory location or storage medium. Although shown separately in FIG. 1 for clarity, the algorithm 100 can be resident in or stored on the storage medium 58, or is otherwise accessible by the server 50 if stored in a separate memory location.

Still referring to FIG. 1, the user 12 utilizes the computer 14 to remotely access the server 50 over the Internet 30 or other suitable network interface or communications link, as indicated by the arrows 11, using the computer 14 and the browser 20, i.e., by entering a predetermined uniform resource locator (URL) into the browser 20. The server 50 can be separated from the computer 14 by a firewall 40 or other suitable network security devices or measures capable of sufficiently protecting or securing any information provided by and to the user 12.

The browser 20 can be adapted to utilize hypertext transfer protocol (HTTP) or HTTP over secure socket layer (HTTPS) in order to access the server 50 over the Transmission Control Protocol/Internet Protocol Suite (TCP/IP). The server 50 itself can be resident on another TCP/IP network, and can selectively interface with additional data sources, such as a custom database (DB 1) 70 and one or more other data sources or databases (DB2) 80, via a switch 60 or other suitable routing device, as indicated by the arrows 13A and 13B. Two-way or query/response communication with the databases 70, 80 is exemplified in FIG. 1 by the arrows 15A, 15B between the switch 60 and the databases 70, 80.

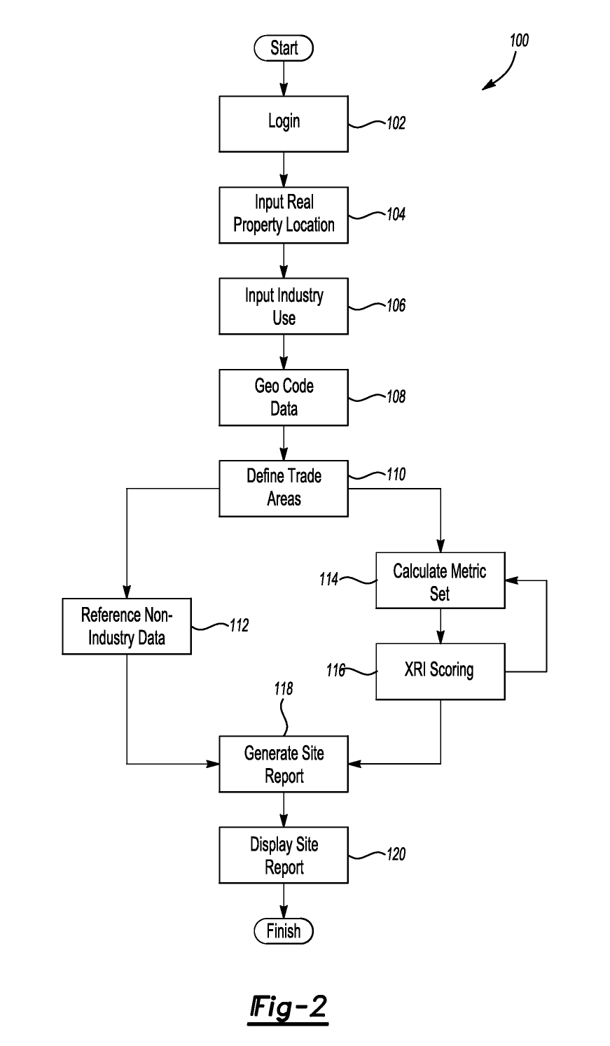

Referring to FIG. 2, and with particular reference to the components of the system 10 shown in FIG. 1, the algorithm 100 is executed beginning with step 102, wherein the user 12 logs in to the server 50 using a predetermined username and password that can be provided to the user 12 upon account registration. In an exemplary embodiment, one of a plurality of different user types can be assigned to the user 12 during account registration, with the assigned user type depending on the particular requirements of the user 12. Exemplary user types can include, without being limited to: Client, Trial, Client Administration, System Administration, etc.

The available options or features presented to the user 12 in subsequent steps can be customized at step 102, and therefore can vary, depending on the particular user type assigned to the user 12 during account registration. Likewise, the scope and content of the report 25 generated by the algorithm 100 can be tailored to the user 12 based at least in part on the user type, for example by limiting a report 25 to a small subset of available information for a user 12 having a user type of “Trial”. Once the user 12 has logged in to the server 50, the algorithm 100 proceeds to step 104.

At step 104, the user 12 is automatically presented with a location query in order to uniquely identify the location of the prospective parcel. Such a query can be presented in any convenient or user-friendly format, including but not necessarily limited to displaying the query on a screen as a data field, as a pull-down field in a database spreadsheet, etc. In particular, at step 104 the user 12 is asked to input a real property location or geographical location, which can take the form of a street address, a desired street intersection, latitude and longitude, GPS coordinates, etc. Once the location of the parcel is entered and recorded in memory 58, the algorithm 100 proceeds to step 106.

At step 106, the user 12 is presented with a list of possible or available intended industry uses. Such a list can include a predetermined default set of the more commonly encountered industry uses, e.g., industrial, residential, commercial, etc., as outlined in the North American Industry Classification System (NAICS). The same list could be customized to the user 12 during account registration to include additional industry uses that are uniquely tailored to match the particular uses in which the user 12 has an interest. Once the desired industry use has been selected or input by the user 12, the intended industry use, hereinafter referred to as the intended use for clarity, is recorded in memory 58, and the algorithm 100 proceeds to step 108.

At step 108, the server 50 processes and automatically geocodes a map location corresponding to the property location entered at step 104. For example, the technology provided by a suitable Geographic Information System (GIS)-based web service can evaluate the location data entered at step 104, and from this can assign a unique geocode to that particular location and surrounding area.

As will be understood by those of ordinary skill in the art, a GIS-based service or application automatically integrates various hardware, software, and other data needed for capturing, managing, analyzing, and displaying all forms of geographically-referenced information, such as but not necessarily limited to the Google Maps™ Application Programming Interface (API). Once the desired property or parcel has been geocoded, the algorithm 100 can return a graphical map and/or an aerial image of the prospective parcel or site, hereinafter referred to collectively as a geocoded graphic, and can include the geocoded graphic in the body of the report 25, as described below. The algorithm 100 then proceeds to step 110.

At step 110, trade areas are automatically defined by the server 25. The particular trade area or areas can be automatically generated as a function of or based on conventional or industry-standard trade area definitions, e.g., a default 10 mile radius from the center point of the candidate parcel. The trade area can also be generated based on a particular default or desired drive time, via user polygons, or other suitable means. Within an exemplary embodiment, the determination of the boundaries of the trade area at step 110 is also informed by urbanicity or population density. For instance, the size of the trade area returned to the user 12 can be automatically adjusted based on population density, such as with the trade area automatically decreasing in size in areas having a relatively low population density, and increasing in size in areas having a relatively high population density. Once the trade areas have been defined at step 110, the algorithm 100 proceeds to steps 112 and 114 simultaneously.

At step 112, the system 10 gathers any required non-industry data from the databases 70 and/or 80, and temporarily records the data in memory within or accessible by the server 50. For example, relevant non-industry data could include, without being limited to: Land Ownership, Mineral Rights, Zoning, Political Boundaries, Consumer Segmentation Model, Wireless Coverage or Boundary Areas, Mobile Wireless Transmission Report, Terrorist Threat Reports, Wireless Usage Reports, Utility Reports such as Gas, Electric, Water, Sewer, Fiber Optic, Pipelines, Crime Reports, Household Media Viewer Consumption Reports, Medical Expenditures Reports, Automotive Type Reports, Magazine subscription Reports, Blood type reports, Race/Demographic Reports, Animal/Pet Reports, GPS Station Reports, Disease Outbreak Reports, Medical Emergency Reports, NSC Reports, government agency reports, Remote Household Monitoring Reports, Household Monitoring Type Reports, etc. The algorithm 100 then proceeds to step 118.

At step 114, the algorithm 1 00 calculates a predetermined set of metrics based on the trade area or areas previously defined at step 1 10. In an exemplary embodiment, the predetermined set of metrics are determined for each of the following ten categories of information: Population Growth, Traffic Counts, Median Income, Average Income, Consumer Expenditure By Intended Use, Trade Area Potential, Building Permit Activity, Household Growth, Average Home Value, and Competitive Locations. However, other metrics can be used in addition to or instead of the exemplary metrics listed hereinabove without departing from the intended scope of the invention. After the desired metrics are calculated at step 114, the algorithm 100 proceeds to step 116.

At step 116, the server 50 processes the metrics to thereby generate an objective scorecard 90 such as of the type shown in FIG. 3, i.e., an objective scorecard or index assigning a numeric weight, value, or grade to each of the metrics calculated at step 114. At step 114, the calculated metrics and any weighted values automatically assigned by the algorithm 100 and/or manually assigned by the user 12 are applied as inputs, and the scorecard 90 is automatically generated. For example, for each of the various metric categories, the associated values can be assigned a corresponding letter. To perform such a conversion, the maximum and minimum values of the metric can be calculated and used to define a max/min range. The range can be divided into a predetermined number of equal parts. For example, if five equal parts are assigned, the letters A-E can be assigned to each segment to define the entire range of values, with a particular letter grade are assigned to each segment.

More specifically, each category of the metrics can be scored as follows: for Population Growth, the maximum and minimum population growth can be determined within a selected radius, with the range (i.e., maximum-minimum) then divided range into five equal parts, with the number five again being purely exemplary. With each part being assigned a corresponding letter, each result can be graded accordingly.

For Traffic Counts: the nearest cross road to the selected property can be selected to represent the approximate center point of a given trade area circle, and its value can be determined for representing the traffic count for the selected property. Next, the maximum and minimum values of traffic counts can be determined for different points within the demarcated circle where such data is available. This range can then be divided into, for consistency of example, five equal parts. Finally, the traffic count value of the selected property relative to that of the demarcated trade area can be matched and graded accordingly.

The above examples sufficiently illustrate the general scoring strategy, and can be followed for most of the remaining categories, i.e., Median Income, Average Income, Consumer Expenditures, Trade Area Potential (i.e., the ratio of Consumer Expenditure and revenue per intended use), Household Growth, and Average Home Value.

For Building Permit Activity, the number of permits in particular trade area (a) can be determined, along with the total number of permits outstanding (b) for a county of other desired geographic area in which selected property falls. The score can determined using the formula: (a/b)*100. The scorecard 90 (see FIG. 3) can represent a particular place/county index. For example, if an analysis of national data determines that there are 1000 outstanding permits, with 20 of these permits being associated with a particular state, and with eight of these 20 permits falling in a particular county, all within the specific place or trade area, a sub-score 94 (see FIG. 4) can be calculated by considering the range of all data for the county total. That is, with all eight outstanding permits falling within the trade area, the place score is (8/8)×100=100. A state score can then be calculated by the state total, or (8/20)×100=40. The state score can be divided by the national total, i.e., (40/1000)×100=4.

For Competitive Locations, two exemplary criteria can be used for grading. The first criteria can include establish a number of competitive locations in a selected radius, and, out of these competitive locations, the maximum and minimum annual revenue can be determined to thereby define a range. The range can be divided, as above, into five equal parts. From all of the competitive locations, the average annual revenue can be calculated and compared with the range, and graded accordingly.

The second criteria can find the center point of all the competitive locations in a selected radius, and then calculate the distances of each location from this geographic center point. The range of distances can then be divided, as above, into five equal parts. The distance (d) of the selected location of intended use from the center point is determined, and compared to the distances of the competitive locations from the same center point. After grading in this manner, the average of the first and the second grading criteria can be used in the scorecard 90.

In calculating the objective scores for use in the scorecard 90, a scoring model or index for the particular industry type can be used to determine weighting. That is, each identified category can be defined by a contribution percentage or value, hereinafter referred to as a weight. If ten categories are set in the system using the exemplary embodiment set forth above, the total contribution is weighed at one hundred (100) total points. However, if a different number of categories are used, or, alternatively, the contribution percentage fails to equal one hundred (100), defined categories not used in the score calculation can be assigned contribution percentages of zero, or if the total percentage is less than 100%, the remaining percentage can be spread equally among all the categories that are used. Once scoring is complete, the algorithm 100 proceeds to step 1 18.

Still referring to FIG. 2, at step 118, the report 25 (see FIG. 1) is automatically generated by the server 50, with the report 25 including at least the scorecard 90 of FIG. 3. In an exemplary embodiment, the report 25 is generated in a plurality of different downloadable formats in order to facilitate use and dissemination of the report 25, with the term “downloadable” as used herein referring to the capability of the user 12 downloading or saving the report 25 to memory 32 of the computer 14.

Likewise, the report 25 can be visually enhanced using customized graphics, colors, fonts, etc., with the scorecard 90 presented and explained in detail in the body of the report 25. In another exemplary embodiment, a real estate comparable report, commonly referred to in the industry simply as a comp report, can be acquired via an external source, for example by accessing and processing data contained in the database 80 shown in FIG. 1. An environmental report or any other desirable report can be acquired in a similar manner via the database 80 or any other reputable data source.

In generating the report 25 at step 118, the algorithm 100 can aggregate the collected and calculated data into a standard template for inclusion in the report 25. In a preferred embodiment, the report 25 contains, where appropriate, some level of analysis and textual and/or graphical depiction of the results, collected under the following sections: a title page, which can include a brief description of the subject parcel such as an address and/or a map or image of the parcel; a table of contents; and an overview presenting a brief statement of value of the appended report 25. The report 25 also includes the scorecard 90, in any embodiment, as well as a site overview including, but not necessarily limited to, the geocoded graphic in the form of a map and/or an image of the parcel with overlaid or demarcated boundaries, usually in the form of a circle, denoting the trade area on the graphic. In addition to these sections, the report 25 can also include a demographic analysis, presented in summary form for each of the various subject areas, e.g., population, households, income, race & ethnicity, housing, employment, etc.

An exemplary executive summary having sufficient brevity could include an entry such as, for the category of “housing”: “[t]he median housing value in this area was $86,785 in 1990, compared with the U.S. median of $78,382 for the same year. The 2000 census median value was $148,376, which is a 71% change from 1990. In 1990, there were 571,661 renter-occupied housing units in this area vs. 566,490 in 2000. The average rent in 1990 was $381 a month vs. $602 a month in 2000”. Other categories could be summarized with a similar scope. Likewise, each summary section can be supported via charts, graphs, or other helpful graphics as needed.

The “demographic analysis” portion of the report 25 can continue with sections detailing population by age in the most recent available year, income by age of head of household/percentage of all households, age by race, etc., and can include a section devoted to a complete demographic comparison, including population trends, household trends, housing unit trends, race and ethnicity trends, etc. A demographic summary can be included that summarizes the population by various criteria, e.g., race/ethnicity, age, income, employment, vehicles per household, marital status, education level, etc.

Still referring to FIG. 2, the report 25 can conclude with additional sections, such as but not limited to “business perspectives”, e.g., consumer expenditures levels and/or gap analysis, business comparisons referenced by SIC and compared by size, industry, services, etc., travel times, means of transportation to work, etc. The report 25 can include any additional sections as desired, such as a traffic data report, a building permit report, and a real estate comparables report as set forth above, as well as a section dedicated to providing any desired or required legal notice, terms of use, etc. Once the report 25 has been generated, the algorithm 100 proceeds to step 120.

At step 120, the report 25 is displayed to the user 12 on the computer 14 via the browser 20, as noted above. Also as noted above, the report 25 is preferably displayed in multiple formats to facilitate end use and dissemination of the report 25. In one exemplary embodiment, the report 25 is displayed in four formats: Word, Excel®, Portable Document Format (PDF), and HyperText Markup Language (HTML). However, the report 25 can be provided in additional or fewer document formats, or different document formats altogether, without departing from the intended scope of the invention. Likewise, as an optional feature the user 12 can request, select, or specify a particular format upon account registration.

Referring to FIG. 3, the scorecard 90 described above is shown in exemplary form. The categories of the metrics described above with reference to step 114 of FIG. 2 can be displayed as a subject column 92, with a corresponding sub-score 94 displayed for each of the categories in the column 92. The total or composite score 96 can be determined as a pure or a weighted average of the sub-scores 94 as explained above, and displayed numerically as shown. The sub-scores 94 and total score 96 can be color-coded or otherwise accented in one exemplary embodiment, as indicated by the texturing of the sub-scores 94 and total or composite score 96 in FIG. 3. That is, relatively high scores could be displayed in a box and accented with a particular color, such as green, while moderate scores can be displayed in yellow or amber, and low scores can be displayed in red. A reference bar or key 95 can be displayed further explaining or qualifying the numeric scores, e.g., with a score of 110 indicating a “go” recommendation with respect to that category, and a score of 0 indicating a “stop” recommendation. The range [110, 0] can then be evaluated on a sliding scale relative to these two extremes. While numeric scores are exemplified in FIG. 3, those of ordinary skill in the art will appreciate that other scoring variables such as letter grades can be also used without departing from the intended scope of the invention.

Using the system 10 of FIG. 1 and the method embodied by algorithm 100 as set forth above, objective information is effectively provided to interested users on parcels of land and/or existing projects that, typically, are difficult and expensive to attain. The generated report 25, including the scorecard 90, allows for objective analysis and comparative studies of candidate parcels, thus reducing costs associated with time, research, and analysis. As the system 10 is completely automated, and is universally accessible to a user over the Internet, customized reports can be provided almost instantaneously anywhere in a predefined global area.

While the best modes for carrying out the invention have been described in detail, those familiar with the art to which this invention relates will recognize various alternative designs and embodiments for practicing the invention within the scope of the appended claims.

1. A method for objectively evaluating a parcel of real estate for an intended use using a server, the method comprising:
recording a location of the parcel and an intended use of the parcel on a first computer-readable medium accessible by the server, wherein the location and the intended use are selected by a user via a computer that is remotely located from the server;
generating a geocoded graphic of an area using the location and a geographic information system (GIS)-based webservice, wherein the area includes the parcel and a predetermined surrounding area;
automatically defining a trade area for the parcel using the server;
demarcating the boundaries of the trade area on the geocoded graphic;
querying at least one database in order to determine a plurality of characteristics of the trade area;
processing the plurality of characteristics on the server to thereby assign an objective score, wherein the objective score grades the trade area for the intended use;
using the server to generate a customized report, wherein the customized report contains at least the objective score; and
automatically displaying the report on the computer in a plurality of predetermined formats, wherein each of the predetermined formats is adapted for downloading to a second computer-readable medium that is accessible to the user via the computer.

2. The method of claim 1, wherein recording an intended use of the parcel includes recoding a data entry of the user on the first computer-readable medium.

3. The method of claim 1, wherein automatically defining a trade area includes defining a circular trade area having an approximately 10 mile radius with respect to a geographic centerpoint of the trade area.

4. The method of claim 1, further comprising:
determining a population density of the trade area, wherein automatically defining a trade area includes automatically adjusting the size of the trade area in response to the population density.

5. The method of claim 1, wherein the plurality of characteristics includes each of: population growth, traffic count, median income, average income, consumer expenditure by intended use, trade area potential, building permit activity, household growth, average home value, and comparable location.

6. The method of claim 1, wherein processing the plurality of characteristics includes assigning a weight to each characteristic based on the intended use of the parcel.

7. A method for objectively evaluating a parcel of real estate for an intended use using a server, the method comprising:
establishing a communications link between a computer and the server, wherein the computer and the server are remotely located with respect to each other;
recording each of a location and an intended use of the parcel on a first computer-readable medium that is accessible by the server;
generating a geocoded map of an area including the parcel using the location;
automatically defining a trade area for the parcel;
demarcating the boundaries of the trade area on the geocoded map;
accessing at least one data source to determine a plurality of characteristics of the trade area;
processing the plurality of characteristics on the server to thereby calculate an objective score for the parcel, wherein the objective score is an objective grade of the trade area for the intended use;
using the server to generate the customized report, wherein the customized report contains at least the objective score; and
displaying the report on the computer via a web browser thereof, wherein the report is configured for downloading to a second computer-readable medium that is accessible to the user via the computer.

8. The method of claim 7, wherein establishing a communications link includes using one of hypertext transfer protocol (HTTP) and HTTP over secure socket layer (HTTPS) to thereby access the server over the Transmission Control Protocol/Internet Protocol Suite (TCP/IP).

9. The method of claim 7, wherein processing the plurality of characteristics to thereby calculate an objective score for the parcel includes determining a corresponding objective score for each of the plurality of characteristics, and then determining the objective score as a function of each of the corresponding objective scores.

10. The method of claim 7, wherein recording an intended use includes displaying a predetermined list of industry uses to the user via a web browser, and then recording the intended use that is selected by the user from the list.

11. The method of claim 7, wherein automatically defining a trade area includes defining one of: a predetermined radius and a predetermined drive time with respect to a geographic centerpoint of the parcel.

12. The method of claim 7, further comprising: determining population density of the trade area, and automatically adjusting the size of the trade area as a function of the population density.

13. A server operable for generating a customized report pertaining to a predetermined parcel of real estate, the server being in remote communication with at least one computer and at least one data source, the server comprising:
a computer-readable medium;
a processor; and
an algorithm resident within the computer-readable medium, wherein the algorithm is adapted for:
recording a location and an intended use of the parcel on the computer-readable medium;
determining a trade area for the parcel;
accessing the at least one data source to determine a set of characteristics pertaining to the trade area; and
processing the set of characteristics via the processor to thereby calculate an objective score for the parcel, wherein the objective score grades the trade area for the intended use;
wherein the server is operable for displaying a customized report via a web browser of the at least one computer, the customized report containing at least the objective score.

14. The server of claim 14, wherein the server is operable for transmitting the customized report to the at least one computer in a plurality of different downloadable formats.

15. The server of claim 15, wherein the plurality of different downloadable formats includes each of: Word, Excel®, Portable Document Format (PDF), and HyperText Markup Language (HTML).

16. The server of claim 15, wherein the server is operable for calculating an objective sub-score for each characteristic in the set of characteristics, and wherein the customized report includes each of the objective sub-scores in addition to the objective score.
